(19) United States
(12) Patent Application Publication
(10) Pub. No.: US 2003/0197302 A1
(43) Pub. Date: Oct. 23, 2003

(54) Thermoplastic olefin composition, process for making the composition and method for negative vacuum forming articles therefrom

(76) Inventors: Srimannarayana Kakarala, Bloomfield Hills, MI (US); Jason B. Clock, Kettering, OH (US); Marty D. Skirha, Vandalia, OH (US)

Correspondence Address: Kathryn Marra, Delphi Technologies, Inc., Legal Staff, 1450 West Long Lake, 4th Floor, Troy, MI, 48098, US

(21) Appl. No.: 10/124,939

(22) Filed: Apr. 17, 2002

(51) Int. Cl. B29C 47/00; B29C 51/10

(52) U.S. Cl. 264/175; 525/240; 264/176.1; 264/544; 264/554

(57) ABSTRACT

A thermoplastic olefin composition comprises, based on the total weight of the composition: about 20 wt % to about 40 wt % polypropylene; about 30 wt % to about 50 wt % ethylene copolymer; and about 20 wt % to about 30 wt % linear low density polyethylene.

A process for negative or female vacuum forming an article comprises: mixing, based upon the total weight of the blend, about 20 wt % to about 40 wt % polypropylene, about 30 wt % to about 50 wt % ethylene copolymer, about 20 wt % to about 30 wt % linear low density polyethylene, and about 0.02 wt % to about 1 wt % to form a blend. The blend is formed into a sheet, disposed in a mold, and vacuum formed into the article.

### TECHNICAL FIELD

The present disclosure relates to thermoplastic olefin compositions, and especially relates to thermoplastic olefin compositions for negative vacuum forming.

### BACKGROUND

Thermoplastic olefin compositions have been developed to replace polyvinyl chloride for the fabrication of many articles. In the automotive field, thermoplastic olefin compositions have been used for the fabrication of articles such as interior sheathing, including instrument panel skins, door panels, air bag covers, roof liners, and seat covers.

The thermoplastic olefin compositions have been employed in various molding methods including injection molding, injection compression molding, extrusion molding, vacuum forming, and air-pressure forming. A vacuum forming process employs negative pressure between a thermoplastic sheet and a mold. (FIGS. 1 and 2) The sheet is heated to a controlled softening temperature, stretched to conform to the mold contours, assisted by the plug assist and vacuum holes in the mold, to impart a desired shape of the part. It is then cooled and excess sheet materials are trimmed to yield a final part. Molds can be either male type (FIG. 2) or negative type (FIG. 1).

Material property requirements for negative vacuum forming applications are different from male vacuum forming applications. Particularly, in parameters such as melt flow rate, depth of draw, resistance to thinning, and coefficient of friction. Commercially available thermoplastic olefin skin materials are formulated for male vacuum forming. One of the properties required for the thermoplastic olefin composition for male vacuum forming is a high grain retention after vacuum forming. In contrast, for female vacuum forming, higher melt flow rate with greater depth of draw and increased resistance to excessive thinning and lower coefficient of friction on tool surface are employed.

### SUMMARY

Disclosed herein is a thermoplastic olefin composition with superior scratch resistance, method for making the same and method for female vacuum forming articles therefrom. The thermoplastic olefin composition comprises, based on the total weight of the composition: about 20 to about 40 wt % polypropylene; about 30 to about 50 wt % ethylene copolymer; and about 20 wt % to about 30 wt % linear low density polyethylene. The polymer blend composition is modified with peroxide free radical initiators to improve melt strength.

The process for vacuum forming an article comprises: melt mixing about 20 wt % to about 40 wt % polypropylene, about 30 wt % to about 50 wt % ethylene copolymer, and about 20 wt % to about 30 wt % linear low density polyethylene to form a blend. The blend is formed into a sheet, disposed in a mold, and vacuum formed into the article.

### BRIEF DESCRIPTION OF THE DRAWINGS

Referring now to the drawings, which are meant to be exemplary, not limiting:

FIG. 1 is a schematic illustration of a negative (female) vacuum forming process; and

FIG. 2 is a schematic illustration of a positive (male) vacuum forming process.

### DETAILED DESCRIPTION

Described herein are flexible thermoplastic olefin compositions, processes for preparing the compositions, and articles of manufacture prepared from the compositions. Flexible thermoplastic olefin compositions refer to those having flex modulus values less than about 60,000 pounds per square inch (psi), preferably about 10,000 psi to about 50,000 psi, more preferably about 20,000 psi to about 50,000 psi. As opposed to greater than 100,000 psi of an injection moldable, hard thermoplastic olefin (TPO). In one embodiment, a thermoplastic olefin composition is disclosed comprising a blend of about 20 weight percent (wt %) to about 40 wt % polypropylene; about 30 wt % to about 50 wt % uncrosslinked ethylene copolymer, and about 20 wt % to about 30 wt % linear low density polyethylene (LLDPE). The weight percent values disclosed are based on the weight of the total composition unless otherwise noted.

The thermoplastic olefin compositions comprise about 20 wt % to about 40 wt %, more preferably about 25 wt % to about 35 wt % polypropylene. Suitable polypropylene includes, but is not limited to, crystalline polypropylene, and is intended to include, in addition to the homopolymer, those polymers that also contain minor amounts, usually not greater than about 15 wt % based on the total weight of the polypropylene, of higher alpha-olefins, e.g., those containing 3 to 8 carbon atoms, such as butene, octene, and the like, as well as combinations comprising at least one of the foregoing polypropylenes. The polypropylene polymers have melt indices of less than or equal to about 1 grams/10 minutes (g/10 min.) measured at 230° C., employing a 2.16 kilogram (kg) weight (commonly known as ASTM test method D-1238).

The thermoplastic olefin composition further comprises about 20 wt % to about 60 wt %, more preferably about 30 to about 50 wt %, ethylene copolymer. Suitable ethylene copolymers include, but are not limited to, ethylene propylene rubber, ethylene butene rubber, ethylene octene rubber, and the like, as well as combinations comprising at least one of the foregoing ethylene copolymers, including copolymers having glass transition temperatures of about −70° C. or less. As used herein, uncrosslinked means that the ethylene copolymer is readily soluble in a solvent (e.g., a hydrocarbon solvent). Preferably, the ethylene copolymer comprises an ethylene propylene non-conjugated diene copolymer (EPDM) is used. The non-conjugated dienes can contain about 6 to about 22 carbon atoms and have at least one readily polymerizable double bond. The uncrosslinked ethylene propylene copolymer rubber contains about 60 wt % to about 80 wt %, usually about 65 wt % to about 75 wt %, ethylene, based on the total weight of the EPDM. The amount of non-conjugated diene is generally about 1 wt % to about 7 wt %, usually about 2 to about 5 wt %, based on the total weight of the EPDM. EPDM copolymers that are especially preferred are ethylene propylene-1,4-hexadiene, ethylene propylene dicyclopentadiene, ethylene propylene norbomene, ethylene propylene-methylene-2-norbomene, and ethylene propylene-1,4-hexadiene/norbomadiene copolymers. These materials provide depth of draw and a soft touch feel to the compositions. It is also preferred that the ethylene copolymers have melt indices of less than or equal to about 1 g/10 min. measured by ASTM D-1238.

The thermoplastic olefin composition may further comprise LLDPE in an amount of about 10 wt % to about 30 wt %, and is preferably employed in an amount of about 20 wt % to about 30 wt %. Suitable LLDPE compounds generally have melt indices (test method ASTM D-1238) of 0.05 to about 5.0 g/10 min. Within this range, the melt indices is preferably greater than or equal to about 0.05 g/10 min. Also within this range, the melt indices is preferably less than or equal to about 2.0, and more preferably less than or equal to about 1.0.

The thermoplastic olefin composition may further comprise suitable polymer modifying chemicals including free radical initiators, preferably organic peroxides, more preferable those with half lives at temperature greater than about 100° C. of less than or equal to about 1 hour. Examples of useful organic peroxides include 1,1-di-t-butyl peroxy-3,3,5-trimethyl cyclohexane, dicumyl peroxide, 2,5-dimethyl-2,5-di {t-butyl peroxy}hexane, t-butyl-cumyl peroxide, di-t-butyl peroxide, 2,5-dimethyl-2,5-di-{t-butyl peroxy}hexyne, and the like, as well as combinations comprising at least one of the foregoing peroxides, with di cumyl peroxide preferred. Several additional examples of organic peroxide crosslinking agents are available in the Handbook of Polymer Foams and Technology. These chemicals may be included in an amount of about 0.05 wt % to about 0.5 wt %, and is preferably employed in an amount of about 0.10 wt % to about 0.40 wt %, based upon the total weight of the thermoplastic olefin composition.

The thermoplastic olefin composition may further comprise suitable co-agents for controlling the pre-radical reaction. A preferred co-agent is tri-methylolpropane trimethacryalate (e.g., TM-350 commercially available from Sartomer Co. located in Pennsylvania). These chemicals may be included in an amount of about 0.05 wt % to about 0.5 wt %, and is preferably employed in an amount of about 0.10 wt % to about 0.40 wt %, based upon the total weight of the thermoplastic olefin composition.

The thermoplastic olefin compositions preferably further comprises stabilizers such as heat stabilizers, light stabilizers, and the like, as well as combinations comprising at least one of the foregoing stabilizers. Heat stabilizers include phenolics, hydroxyl amines, phosphites, and the like, as well as combinations comprising at least one of the foregoing heat stabilizers. Light stabilizers include low molecular weight (having number-average molecular weights (AMU) less than about 1,000 AMU) hindered amines, high molecular weight (having number-average molecular weights greater than about 1,000 AMU) hindered amines, and the like, as well as combinations comprising at least one of the foregoing light stabilizers. Suitable stabilizers are known in the art, and the amount of stabilizer is readily empirically determined by the reaction employed and desired characteristics of the finished article, with up to about 4 wt % stabilizer possible, and about 1 wt % to about 4 wt % preferred.

In addition to the above optional components, the thermoplastic olefin compositions can also optionally comprise a color additive, such as a pigment, dye, or the like, as well as combinations comprising at least one of the foregoing color additives. The amount of color additive is readily empirically determined based on the desired color characteristics of the finished article, with less than or equal to about 10 wt % color additive possible, greater than or equal to about 0.5 wt % typical, and about 1 wt % to about 5 wt % preferred, based upon the total weight of the thermoplastic olefin composition.

The thermoplastic olefin compositions have certain properties that are specifically desirable for female or negative vacuum forming, also known as in mold grain forming. Thermoplastic olefin compositions for all extrusion applications generally have melt indices (measured at 230° C. and employing a 10 kilogram (kg) weight) of about 1 to about 20 g/10 min. Melt indices preferable for male or positive vacuum forming is less than about 6. However, for female or negative vacuum forming the melt indices are greater than or equal to about 10 g/10 min. Lower viscosity, as indicated by the composition's melt index, is desirable for female vacuum forming because lower viscosity allows for more flow when the material is vacuum formed. Higher flow is desirable in order to better fill the grain being imparted by the vacuum form tooling.

This thermoplastic olefin composition is a blend that may be formed using reaction extrusion compounding. Possible techniques include melt blending, preferably under high distributive mixing with low shear conditions; in-line compounding; extruding; in-line thermoforming; calendering; and the like, as well as combinations comprising at least one of the foregoing techniques. Furthermore, the processing of the materials in a single manufacturing step, i.e., concurrent in-line compounding and reactive extruding forms the final sheet and eliminates the step of pellet processing, thus reducing the need for heat stabilizers and other additives. Significant cost savings are realized by in-line compounding of the composition and thermoforming articles therefrom.

The production techniques can be accomplished by employing equipment such as extruders, mixers, kneaders, and the like. Suitable extruders include twin screw or single screw extruders. A particularly well-suited extruder has a L/D (length of screw/barrel diameter) ratio of greater than 28:1, and further includes dispersive and distributive mixing capability. The components may be introduced into the extruder through a single feed or through multiple feeds. In an alternate embodiment, recycled materials (e.g., formed from scraps of a precompounded composition) may be extruded through an extruder. In either embodiment, extrudate is passed from the extruder through a process suitable for forming sheets. For example, the extrudates may be processed through a layer die followed by embossing rollers. For female vacuum forming, a shallow embossed pattern with a depth of less than or equal to about 0.005 inches is desirable. A geometric stipling pattern comprising half domes has been found to be particularly preferred. This pattern is employed for the female vacuum forming process to assist in air evacuation during forming and for ease of coating. The extruded sheets are typically transferred to rolls for forming articles of manufacture therefrom.

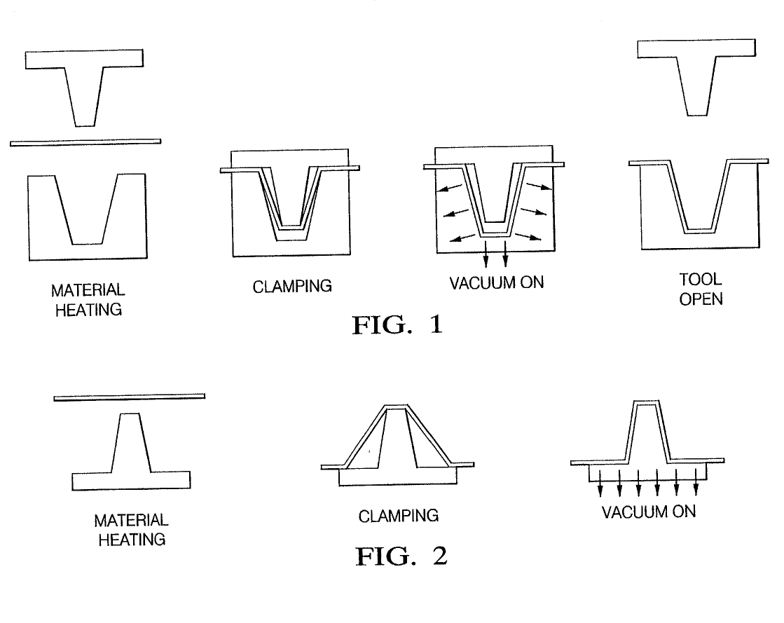

The female vacuum forming process comprises indexing the extruded sheet into a heating station where a pre-defined thermal pattern heats the sheet to the desired temperature appropriate for vacuum forming a particular part. The heated sheet is then indexed to the vacuum forming station where a plug assist pushes the sheet into the female cavity. After the tool is clamped, vacuum is applied to pull the sheet into the female cavity and form the final shape. The tool halves separate and the skin is removed from tool. (See FIG. 1)

Optionally, a sheet may comprise separate layers, which include thermoplastic olefin compositions that may be formed or extruded separately, and subsequently layered in a sheet die. A first layer and a second layer, for example, may comprise the same or different thermoplastic olefin compositions. In one embodiment, the first layer comprises virgin material, and the second layer comprises a combination of virgin material and recycled material (e.g., including previously compounded first and second layers).

The following examples illustrate specific thermoplastic olefin compositions suitable for use with the above and other processes. Table 1 provides a list of components used in the present examples, along with tradenames and sources for the components. It should be understood that the examples are given for the purpose of illustration and are not intended as limitations.

TABLE 1

| Component | Source | Tradename |
|---|---|---|
| Polypropylene | Amoco ®, Basell ®, | E.g., Accpro ®, |
| | ExxonMobil ®, | available |
| | Equistar ®, | from Amoco ® |
| Ethylene elastomer | DuPont-Dow | Engage ® |
| (e.g. EPDM, EPR, EOR, | Elastomers ® | Nordel ® |
| EBR) | ExxonMobil ® | Exact ® |
| | | Vistalon ® |
| Peroxide crosslinking | Commerically avail- | Luperox ®, |
| (e.g. Dicumyl peroxide) | able from many | TM-350 |
| | sources such as Elf- | |
| | Atochem ® | |
| | and Sartomer ® | |
| LLDPE (Linear Low | Equistar ® | Petrothene ® |
| Density Polyethylene) | | |
| Heat and UV stabilizers | Commercially | Tinuine ® |
| and color pigments | available from many | (UV stabilizer) |
| | sources such as Ciba | Chemisorb ® |
| | Specialty Chemicals ® | (heat and UV |
| | Americhem ® | stabilizer) Color & |
| | | Pigments |

Compositions were prepared having proportions as set forth in Table 2, and processed into extruded sheets.

TABLE 2

| | Sample # | | | | |
|---|---|---|---|---|---|
| | (parts per weight unit of total compound) | | | | |
| Component | 1 (control) | 2 | 3 | 4 | 5 |
| Polypropylene | 30.0 | 25.0 | 25.0 | 25.0 | 25.0 |
| Ethylene | 70.0 | 55.0 | 50.0 | 50.0 | 50.0 |
| Copolymer | | | | | |
| LLDPE (Linear | 0.0 | 20.0 | 25.0 | 25.0 | 25.0 |
| Low Density | | | | | |
| Polyethylene) | | | | | |
| Phenolic | 0.2 | 0.2 | 0.2 | 0.2 | 0.2 |
| Stabilizer | | | | | |
| (PHR) | | | | | |
| Dicumyl | 0.0 | 0.0 | 0.10 | 0.20 | 0.30 |
| Peroxide(PHR) | | | | | |
| Co-Agent [TM- | 0.0 | 0.0 | 0.30 | 0.20 | 0.10 |
| 350] (PHR) | | | | | |
| Color | 4.0 | 4.0 | 4.0 | 4.0 | 4.0 |
| Concentrate | | | | | |
| (PHR) | | | | | |

The above formulations were tumble mixed by a ribbon blender and fed into a twin screw extruder having a mixing screw configuration to provide high distributive mixing at low shear with a residence time between 30 to 45 seconds. The ingredients were compounded into pellet form. Pellets were extruded in a single screw extruder through a slot die and calendared to a sheet thickness of one millimeter.

These sheets were vacuum formed on a negative forming tool. The ease of vacuum forming was determined by rating the difficulty of start up and the width of the process window.

Sheets were then subjected to the five finger scratch test. This test comprises dragging one millimeter steel tips with varying loads at a set rate. The resulting scratches are given a qualitative rating. The results were ranked one through five on the chart below.

Material cost was calculated using commercial costs of each ingredient.

Melt strength was measured on the compounded pellets using a capillary rheometer heated to 190° C. fitted with a Gottfert Rheotens attachment. The melt strength was measured as load to break the filaments exiting the capillary die.

TABLE 3

| | Sample Number | | | | |
|---|---|---|---|---|---|
| | 1 | | | | |
| Property | (control) | 2 | 3 | 4 | 5 |
| Melt Strength | 7 | 9 | 13 | 15 | 14 |
| @ 190° C. [cN] | | | | | |
| Scratch | 4 | 2 | 1 | 1 | 1 |
| Resistance | | | | | |
| @ 7N (1 is | | | | | |
| best) | | | | | |
| Ease of | 5 | 4 | 3 | 1 | 2 |
| Vacuum | | | | | |
| Forming (1-5, | | | | | |
| 1 is best) | | | | | |
| Material Cost | 5 | 1 | 2 | 3 | 4 |
| (1 is best) | | | | | |

Referring to Table 3, the thermoplastic olefin composition described herein exhibits superior scratch resistance over conventional (control) thermoplastic olefin compositions for automotive interior skin applications. Scratch resistance is measured by a 5 Finger Scratch Test with variable loads on a 1 mm diameter probe. The damage to the materials is given a qualitative score ranging from 1 to 5, 1 being the best. (See Table 3)

The thermoplastic olefin compositions, process, and articles made therefrom, although primarily described in relation to vehicle applications such as interior sheathing, including instrument panel skins, door panels, air bag covers, roof liners, and seat covers, can be utilized in numerous applications, including, but not limited to, other transportation interiors such as those found in locomotives, airplanes, and watercrafts; home furnishings; and luggage, among others.

The thermoplastic olefin compositions are particularly useful in female vacuum forming. The compositions are low cost due to the use of commodity raw materials with low concentration of modifiers (less than or equal to about 0.5 wt %, based upon the total weight of the composition) during the melt mixing process. Further cost reduction is obtained with direct extrusion of the sheet instead of first forming pellets. Additionally the composition comprises a high depth of draw, e.g., greater than or equal to about 250%, enabling the formation of complex contours and undercuts while maintaining good grain formation.

While preferred embodiments have been shown and described, various modifications and substitutions may be made thereto without departing from the spirit and scope of the invention. Accordingly, it is to be understood that the apparatus and method have been described by way of illustration only, and such illustrations and embodiments as have been disclosed herein are not to be construed as limiting to the claims.

What is claimed is:

1. A thermoplastic olefin composition, comprising, based on the total weight of the composition:
about 20 wt % to about 40 wt % polypropylene;
about 30 wt % to about 50 wt % ethylene copolymer; and
about 20 wt % to about 30 wt % linear low density polyethylene.

2. The composition of claim 1, further comprising about 25 wt % to about 30 wt % of the polyethylene.

3. The composition of claim 1, wherein the polypropylene, the ethylene copolymer, and the linear low density polyethylene each have a melt index of less than or equal to about 1 g/10 min. measured at 230° C., employing a 2.16 kg weight.

4. The composition of claim 1, further comprising about 0.5 wt % to about 10 wt % color additive, based upon the total weight of the thermoplastic olefin composition.

5. The composition of claim 4, further comprising about 1 wt % to about 5 wt % of the color additive.

6. The composition of claim 1, further comprising about 30 wt % to about 70 wt % of the ethylene copolymer.

7. The composition of claim 1, wherein the ethylene copolymer further comprises EPDM, and wherein the EPDM comprises about 40 wt % to about 60 wt % ethylene, based on the total weight of the EPDM.

8. The composition of claim 1, further comprising about 0.05 to about 4 wt % stabilizers, based upon the total weight of the thermoplastic olefin composition.

9. The composition of claim 1, further comprising about 0.05 wt % to about 0.5 wt % free radical initiators, based upon the total weight of the thermoplastic olefin composition.

10. The composition of claim 9, further comprising about 0.1 wt % up to about 0.4 wt % of the free radical initiators, wherein the free radical initiators comprise an organic peroxide.

11. The composition of claim 1, further comprising about 0.05 wt % to about 0.5 wt % of a pre-radical controlling co-agent.

12. The composition of claim 1, wherein the co-agent comprises tri-methylolpropane trimethacryalate.

13. An article of manufacture made from the composition of claim 1.

14. The article of manufacture of claim 13, wherein the article of manufacture is selected from the group consisting of sheathing, instrument panel skins, airbag housing covers, and door trims.

15. A process for preparing a thermoplastic olefin composition comprising:
mixing about 20 wt % to about 40 wt % polypropylene, about 30 wt % to about 50 wt % ethylene copolymer, and about 20 wt % to about 30 wt % linear low density polyethylene to form a blend, based upon the total weight of the blend; and
extruding the blend.

16. The process of claim 15, wherein the mixing further comprises melt blending.

17. The process of claim 16, further comprising calendaring the blend.

18. The process of claim 15, wherein the mixing further comprises in-line compounding.

19. The process of claim 15, wherein sheet is embossed with a shallow geometric stiple grain.

20. The process of claim 15, further comprising mixing about 0.05 wt % to about 0.5 wt % free radical initiators, based upon the total weight of the blend, into the blend.

21. The process of claim 20, wherein the amount of free radical initiators is about 0.1 wt % up to about 0.4 wt %, and wherein the free radical initiators comprise an organic peroxide.

22. The process of claim 15, further comprising mixing about 0.05 wt % to about 0.5 wt % of a pre-radical controlling co-agent, based upon the total weight of the blend, into the blend.

23. A process for female vacuum forming an article, comprising:
mixing about 20 wt % to about 40 wt % polypropylene, about 30 wt % to about 50 wt % ethylene copolymer, and about 20 wt % to about 30 wt % linear low density polyethylene to form a blend, based upon a total weight of the blend; and
forming a sheet from the blend;
disposing the sheet in a mold; and
vacuum forming the sheet into an article.

24. A thermoplastic olefin composition, comprising the reaction product of, based on the total weight of the composition:
about 20 wt % to about 40 wt % polypropylene;
about 30 wt % to about 50 wt % ethylene copolymer; and
about 20 wt % to about 30 wt % linear low density polyethylene;
wherein the polypropylene, the ethylene copolymer, and the linear low density polyethylene each have a melt index of less than or equal to about 1 g/10 min. measured at 230° C., employing a 2.16 kg weight.
